(19) United States
(12) Patent Application Publication
(10) Pub. No.: US 2013/0100419 A1
(43) Pub. Date: Apr. 25, 2013

(54) BEAM PROJECTOR WITH EQUALIZATION LENS

(71) Applicant: Samsung Electronics Co., Ltd., Gyeonggi-do (KR)

(72) Inventors: Yong-Kwan KIM, Gyeonggi-do (KR); Seong-Ha Park, Gyeonggi-do (KR)

(73) Assignee: Samsung Electronics Co., Ltd., Gyeonggi-do (KR)

(21) Appl. No.: 13/657,343

(22) Filed: Oct. 22, 2012

(30) Foreign Application Priority Data
Oct. 21, 2011 (KR) 10-2011-0108198

(51) Int. Cl. G03B 21/28

(52) U.S. Cl. 353/31; 353/98; 353/38

(57) ABSTRACT

A projector for projecting light forming an image on an external screen to outside of the projector includes a display panel provided with a plurality of pixel elements, and configured to form an image by controlling the pixel elements according to a driving signal, an illumination optical system provided with an equalization lens and a mirror arranged on a first optical axis, and configured to output light penetrating the equalization lens to the display panel through the mirror, and a projection optical system provided with at least one lens arranged on a second optical axis, and configured to output light reflected from the display panel to the outside, wherein an alignment axis of the equalization lens forms an angle of inclination with the second optical axis.

### PRIORITY

This application claims priority under 35 U.S.C. §119(a) to Korean Application Serial No. 10-2011-0108198, which was filed in the Korean Intellectual Property Office on Oct. 21, 2011, the contents of which are incorporated herein by reference.

### BACKGROUND OF THE INVENTION

1. Field of the Invention

The present invention relates generally to a beam projector, and more particularly, to a micro beam projector including a light source, such as a Light Emitting Diode (LED) or a lamp, an illumination optical system, and a projection optical system.

2. Description of the Related Art

Technical developments for a micro beam projector are underway, in which the micro beam projector is configured to project and display content or a moving picture stored in a display apparatus, such as a portable phone, a computer, an MPEG-Layer Audio 3 (MP3) player, or a micro digital camera, to the outside as an image. A conventional micro beam projector includes a micro flat display panel, such as a Digital Micro-mirror Device (DMD) or a Liquid Crystal Display (LCD).

In addition, a conventional beam projector includes an illumination optical system and a projection optical system. The illumination optical system refers to an optical system aligned on an optical path from a light source to a display panel, and the projection optical system refers to an optical system on an optical path from the display panel to an external screen.

A required size of a beam projector is gradually reduced so that the beam projector is equipped within a micro display device. For example, the thickness of a beam projector is reduced to a certain degree by cutting a peripheral area of an optical device which is used for configuring an illumination optical system. However, the cutting may prevent a portion of light output from the light source from arriving at the display panel, and hence the illumination efficiency is deteriorated.

### SUMMARY OF THE INVENTION

Accordingly, an aspect of the present invention is to improve on the above-described problems and/or disadvantages occurring in the prior art.

Another aspect of the present invention is to provide a micro beam projector, of which the thickness is reduced without deteriorating the illumination efficiency thereof.

In accordance with an aspect of the present invention, a beam projector for projecting light which forms an image on an external screen, to outside of the projector is provided. The projector includes a display panel provided with a plurality of pixel elements, and configured to form an image by controlling the pixel elements according to a driving signal, an illumination optical system provided with an equalization lens and a mirror arranged on a first optical axis, and configured to output light penetrating the equalization lens to the display panel through the mirror, and a projection optical system provided with at least one lens arranged on a second optical axis, and configured to output light reflected from the display panel to the outside, wherein an alignment axis of the equalization lens forms a preset angle of inclination with the second optical axis.

### BRIEF DESCRIPTION OF THE DRAWINGS

The above and other aspects, features, and advantages of the present invention will be more apparent from the following detailed description taken in conjunction with the accompanying drawings, in which:

FIG. 1 illustrates a basic construction of a micro beam projector according to an embodiment of the present invention;

FIG. 2 illustrates an equalization lens in detail;

FIG. 3 illustrates a detailed construction projection optical system;

FIG. 4 illustrates a region of light illuminated to a display panel when an illumination optical system is moved;

FIG. 5 is a diagram for describing the rotation of a mirror;

FIG. 6 illustrates a region of light illuminated to the display panel when the mirror is rotated;

FIG. 7 is a diagram for describing the rotation of an equalization lens; and

FIG. 8 illustrates a region of light illuminated to the display panel when the equalization lens is rotated.

### DETAILED DESCRIPTION OF EMBODIMENTS OF THE PRESENT INVENTION

Hereinafter, embodiments of the present invention will be described with reference to the accompanying drawings. In the following description, various specific definitions, such as particular components, found in the following description are provided only to help general understanding of the present invention, and it is apparent to those skilled in the art that the present invention can be modified or changed within the scope of the present invention. Further, a detailed description of known functions and configurations incorporated herein will be omitted for the sake of clarity and conciseness.

Although ordinal numbers, such as first and second, are used in the examples of the present invention described below merely to differentiate the objects with the same name from each other, the order of the objects may be arbitrarily determined and a preceding description may be applied to a postfix element.

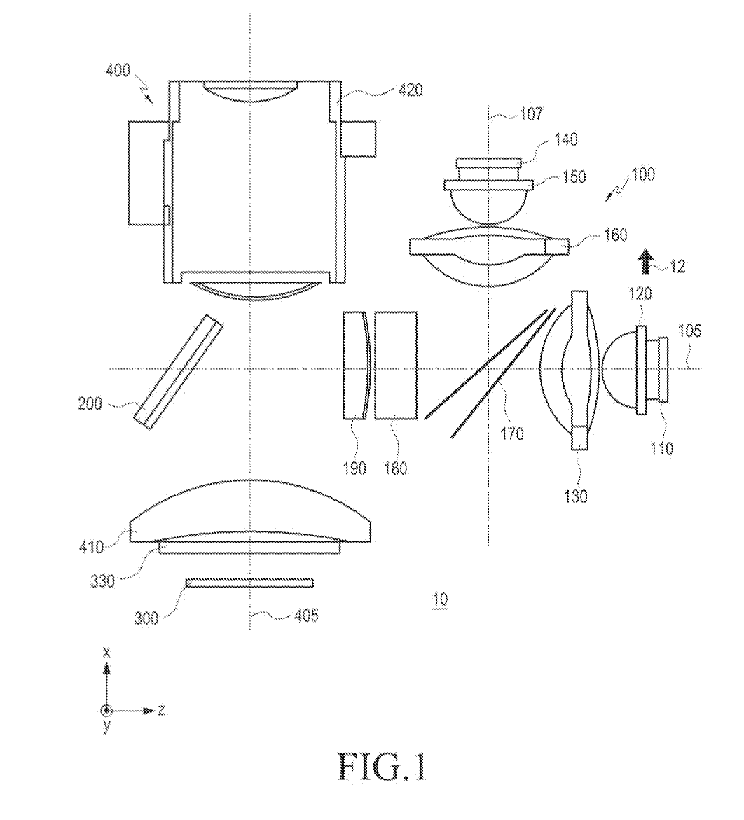

FIG. 1 illustrates a basic construction of a micro beam projector according to an embodiment of the present invention. The beam projector 10 includes first and second light sources 110 and 140, an illumination optical system 100 configured to illuminate a display panel 300 with the light output from the first and second light sources 110 and 140, a display panel 300 configured to reflect the light as an unit of pixel to form an image, a mirror 200, and a projection optical system 400 configured to project the light reflected from the display panel 300 to an external screen. In the present embodiment, a first optical axis 105 is parallel to a z-axis, and each of an auxiliary optical axis 107 and a second optical axis 405 is parallel to an x-axis. However, it is not necessary for the first and second optical axes 105 and 405 to always cross at right angles, and it is also not necessary for the auxiliary optical axis 107 to always be parallel to the x-axis. The above-described arrangement is merely an example.

The illumination optical system 100 has the first optical axis 105 and the auxiliary optical axis 107, and includes the first and second light sources 110 and 140; first to fourth collimation lenses 120, 130, 150 and 160; a filter 170; an equalization lens 180; and a relay lens 190. The second light source 140 and the third and fourth collimation lenses 150 and 160 are arranged on the auxiliary optical axis 107, and the remaining optical devices of the illumination optical system 100 are arranged on first optical axis 105. Although FIG. 1 illustrates use of a plurality of light sources, of which the output lights are capable of being mixed with each other to produce a white light, there also may be used a single light source for outputting lights of various colors (for example, a wavelength-variable light source), three light sources according to three primary colors Red, Green and Blue (RGB), or a white light source is used together with a color filter. Typically, an optical axis refers to an axis which does not cause an optical variation even if an optical system is rotated about the axis. Being aligned on an optical axis indicates that a center of curvature of an optical device of a corresponding optical system is positioned on the optical axis or a symmetrical point (a symmetrical center) or a central point of the optical device is positioned on the optical axis.

The first light source 110 outputs a first primary color light progressing along the first optical axis 105. For example, an LED, which outputs a green light, is used as the first light source 110. In the present embodiment, the first light source 110 outputs a first primary color light which diverges in an angle about the first optical axis 105. Unlike this, a collimation lens is incorporated in the first light source 110, in which case the first collimation lens is removed.

The first and second collimation lenses 120 and 130 receive the first primary color light output from the first light source 110 and diverged, and collimate (i.e., parallelize) and output the first primary color light. The term, “collimating” refers to reducing the divergence angle of a light, and ideally refers to causing the light progress to be in parallel without being converged or diverged. The present embodiment uses the first and second collimation lenses 120 and 130 which form a pair in order to gradually collimate the first primary color light output from the first light source 110 (that is, the first and second collimation lenses 120 and 130 gradually parallelize the first primary color light), or to divisionally collimate the first primary color light in two directions which are at right angles (that is, the first collimation lens 110 collimates the first primary color light in the first direction (for example, the y-axis direction), and the second collimation lens 130 collimates the first primary color light in a second direction (for example, the x-axis direction) which is at right angles in relation to the first direction). However, a single collimation lens may be used.

The second light source 140 outputs second and third primary color lights progressing along the auxiliary optical axis 107. For example, 2 LEDs, which output red light and blue light, respectively, may be used as the second light source 140.

The third and fourth collimation lenses 150 and 160 receive the second and third primary color lights output from the second light source 140 and diverged, and collimate and output the second and third primary color lights.

Unlike the present embodiment, the second and third primary color light sources may exist separately, in which case the collimation lenses may exist in front of the primary color light sources, respectively. For example, another filter, which transmits the third primary color light from third primary color light source laid on the auxiliary optical axis 107 and reflects the second primary color light from the second primary color light source laid substantially at right angles in relation to the light auxiliary optical axis 107 and substantially parallel to the first optical axis 105, is positioned in front of the filter 170 laid on the first optical axis 105 (that is, between the third primary color light source and the filter 170 on the auxiliary optical axis 107).

The filter 170 reflects the second and third primary color lights input from the fourth collimation lens 160 to progress along the first optical axis 105, and transmits the first primary color light input from the second collimation lens 130 as it is. For example, a wavelength-selective filter (or a dichroic filter), which selectively performs transmission or reflection according to a wavelength, a dichroic mirror or a prism is used as the filter 170, or a wavelength-independent filter, such as a beam splitter or a half mirror, is used. The first to third primary color lights are made to progress along the same first optical axis 105 by the filter 170.

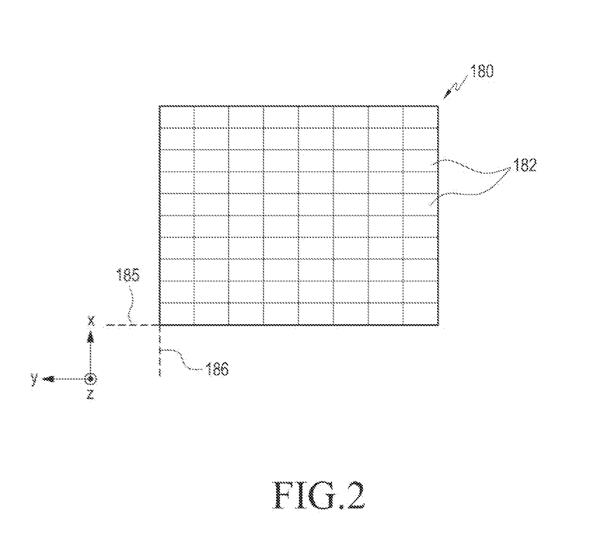

FIG. 2 illustrates an equalization lens in detail. The equalization lens 180 intensity-equalizes and outputs a light input from the filter 170. That is, the equalization lens 180 equalizes the intensity distribution of the light on the x-y plane. A fly eye lens is used as the equalization lens 180, by which the aspect of the light is matched with that of the display panel 300, and the chromatic uniformity of the light is improved.

The equalization lens 180 is formed from a plurality of micro lenses 182 arranged in a matrix structure to form a rectangular shape in aggregate. The row direction alignment axis 185 of the micro lenses 182 is parallel to the x-axis, and the column direction 186 of the micro lenses 182 is parallel to the y-axis. Each of the micro lenses 182 generally has a rectangular shape. The intensity distribution of the light incident to the equalization lens 180 has a Gaussian distribution, i.e. a shape in which, with reference to the first optical axis 105, the intensity at the central area is high, and the intensity at the marginal area is low. The equalization lens 180 equalizes the intensity distribution of the incident light and then outputs the light.

The relay lens 190 and a condensing lens 410, shown in FIG. 1, cause the light input from the equalization lens 180 to be focused to the surface of the display panel 300.

The mirror 200 receives light from the relay lens 190, and reflects the light to the display panel 300 side. A flat mirror is used as the mirror 200, which may have a structure with a dielectric layer or a metallic layer with a high reflectance deposited on a substrate.

Considering overfill, the condensing lens 410 renders the light reflected from mirror 200 to be matched to the display panel 300. That is, the condensing lens 410 renders the reflected light to be incident to an area larger than that of the display panel 300. An Anti-Reflection (AR) coating is applied to the optical surface of each of the lenses of the projector 10 so as to minimize the reflection of light incident to the surface. Such an AR coating layer is configured to minimize the reflection of light incident to the surface thereof, and is formed from a plurality of layers of any materials on a condition that the layers are configured by alternately laminating layers with a high refractive index (for example, Nb₂O₅ layers) and layers with a low refractive index (for example, SiO₂ layers). Particularly, since the light reflected from the screen side optical surface of the condensing lens 410 may cause a large noise on an image, it is desirable to apply AR coating on the screen side optical surface.

The display panel 300 displays an image as a unit of pixel, in which the display panel 300 includes pixel elements corresponding to a preset resolution and displays an image through ON/OFF driving of the pixel elements. In the present embodiment, a DMD including micro mirrors arranged in an M×N matrix arrangement (for example, 1280×720, 854×480 or the like) is used as the display panel 300. Alternatively, an LCoS (Liquid Crystal On Silicon) panel is used as the display panel 300.

Each of the micro mirrors is rotated to a position corresponding to an ON condition or a position corresponding to an OFF condition according to a driving signal. When in the ON condition, each micro mirror reflects incident light at an angle where the incident light is capable of being displayed on a screen, and when in the OFF condition, each micro mirror reflects the incident light at an angle where the incident angle is not displayed on the screen. The display panel 300 may further include a circuit board for providing a driving signal to each of the pixel elements.

The projection optical system 400 has a second optical axis 405, and includes a condensing lens 410, and a projection lens 420. The condensing lens 410 and the projection lens 420 are arranged on the second optical axis 405.

The condensing lens 410 receives light from the illumination optical system 100, and allows the light to be incident to the display panel 300 at a uniform angle. In addition, the condensing lens 410 receives light reflected from the display panel 300, and outputs the light after reducing the beam spot size of the light. Since the light reflected from the display panel 300 has a large beam spot size, the light, which is not transmitted to the projection lens 420, may result in a significant loss. The condensing lens 410 concentrates light reflected from the display panel 300 and reduces the beam spot size of the light, thereby allowing the light to be transmitted to the projection lens 420 as much as possible.

The projection lens 420 receives the light with a controlled beam spot size from the condensing lens 410, and projects the light to the screen at a preset area so that a focus of the light is formed on the screen. That is, the focal distance of the projection lens 420 is capable of being adjusted as some or all of the optical devices of the projection lens 420 are automatically or manually moved, and the projection lens 420 may allow an image displayed on display panel 300 to be enlarged and displayed on the screen.

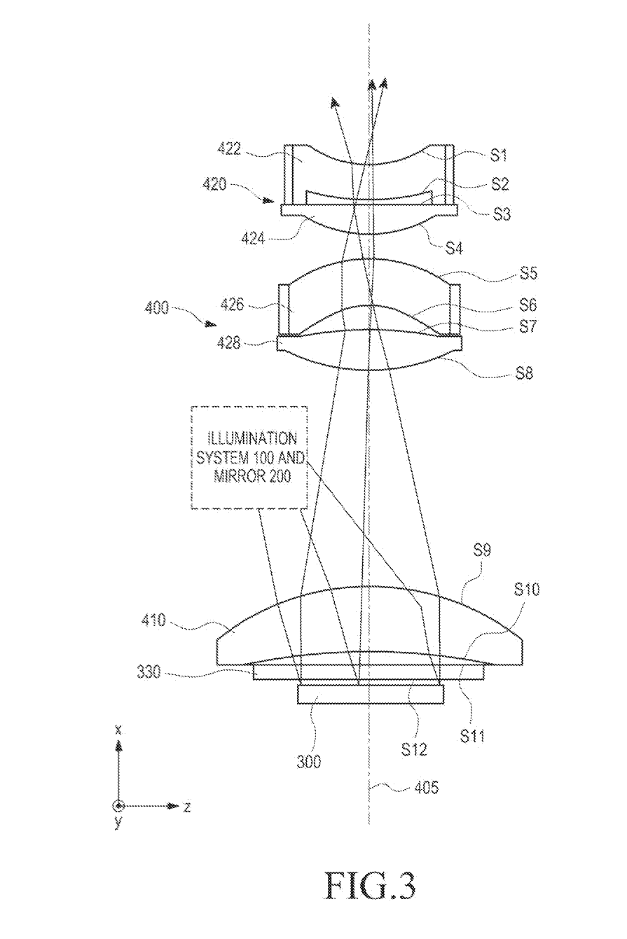

FIG. 3 illustrates a detailed construction of the projection optical system. Although the shape of optical surfaces is described with reference to Table 1 below, the optical surface of each of the lenses of the projector 10 may be a spherical or aspheric surface.

Table 1 indicates numerical data of the optical devices of the projection optical system 400. Table 1 shows the radius of curvature of the iₜₕ optical surface (Sᵢ), the thickness or air spacing of the iₜₕ optical surface (or the distance from the ith optical surface to the (i+1)ₜₕ optical surface) D, the refractive index at the d line (587.5618 nm) of the iₜₕ optical surface) N, the Abbe number V of the iₜₕ optical surface. The unit of the radius of curvature and the thickness is mm. The optical surface number i is sequentially denoted from the screen side to the display device 300 side.

TABLE 1

| Surface | Radius of | Between | | | |
|---|---|---|---|---|---|
| number | curvature (mm) | surfaces | D (mm) | N | V |
| 1 | −2.50 | 1-2 | 1.30 | 1.5311 | 55.80 |
| 2 | −4.65 | 2-3 | 0.10 | 1.0000 | |
| 3 | 13.00 | 3-4 | 1.78 | 1.5311 | 55.80 |
| 4 | −4.84 | 4-5 | 1.99 | 1.0000 | |
| 5 | 7.56 | 5-6 | 0.97 | 6.3200 | 23.00 |
| 6 | 3.07 | 6-7 | 1.88 | 1.0000 | |
| 7 | | 7-8 | 2.50 | 1.6204 | 60.34 |
| 8 | −8.12 | 8-9 | 8.04 | 1.0000 | |
| 9 | 10.80 | 9-10 | 3.00 | 1.6584 | 50.85 |
| 10 | 40.80 | 10-11 | 0.60 | 1.0000 | |
| 11 | | 11-12 | 0.65 | 1.5069 | 63.10 |
| 12 | | 12- | 0.71 | 1.0000 | |
| | | Display | | | |
| | | device | | | |

In Table 1, the first to sixth optical surfaces (S1-S6) are aspheric surfaces, a radius of curvature is not described when a corresponding optical surface is a flat surface, and the refractive index of air is 1.

An aspheric surface is defined by Equation (1) below.

$$z = \frac{{ch}^{2}}{1 + SQRT \{ 1 - ( 1 + k ) {c}^{2} {h}^{2} \}} + {Ah}^{4} + {Bh}^{6} + {Ch}^{8} + {Dh}^{10} + {Eh}^{12} + {Fh}^{14} + {Gh}^{16} \qquad ( 1 )$$

In Equation (1), z is a distance from the center (or apex) of an optical surface along the optical axis 405, h is a distance in a direction perpendicular to the optical axis 405, c is a curvature at the center of an optical surface (an inverse number of radius of curvature), k is a conic coefficient, and A, B, C, D, E, F and G (=0) are aspheric parameters.

The aspheric parameters of respective aspheric surfaces of Table 1 are shown in Table 2.

TABLE 2
Aspheric parameters

| Surface | k | A | B | C | D | E | F |
|---|---|---|---|---|---|---|---|
| 1 | −0.5868604 | 0.02061595 | −0.001949 | 0.00021047 | −1.59E−05 | 7.49E−07 | −1.28E−08 |
| 2 | −1.16E+00 | 1.06E−02 | −0.000804 | 4.41E−05 | −3.03E−06 | 8.95E−08 | 2.92E−10 |
| 3 | −1.72E+00 | −3.78E−03 | 0.0002273 | −5.05E−06 | −2.94E−06 | 3.28E−07 | −1.69E−08 |
| 4 | −5.72E−01 | 6.52E−05 | 0.0001916 | −2.90E−05 | 1.84E−06 | −2.62E−08 | −4.35E−09 |
| 5 | −2.58E−01 | −1.65E−03 | 0.0001027 | −9.10E−06 | 7.09E−07 | −2.79E−08 | 4.08E−10 |
| 6 | −8.46E−01 | −7.19E−03 | 0.0004096 | −2.58E−05 | 1.35E−06 | −4.42E−08 | 6.09E−10 |

The projection lens 420 of the projection optical system 400 includes first to fourth lenses 422, 424, 426 and 428 arranged in this order from the screen side to the display panel 300 side.

The first lens 422 has first and second optical surfaces S1 and S2, both of which are convex to the display panel side, in which each of the first and second optical surfaces S1 and S2 is an aspheric surface.

The second lens 424 has third and fourth convex optical surfaces S3 and S4 at the opposite sides thereof, in which each of the third and fourth optical surfaces S3 and S4 is an aspheric surface. Two cemented lenses may be used as a combination of the first and second lenses 422 and 424.

The third lens 426 has fifth and sixth optical surfaces S5 and S6, both of which are convex toward the screen side, in which each of the fifth and sixth optical surfaces S5 and S6 is an aspheric surface.

The fourth lens 428 has seventh and eighth flat-convex optical surfaces S7 and S8, in which the eighth optical surface S8 is a spherical surface. Two cemented lenses may be used as a combination of the third and fourth lenses 426 and 428. Unlike the present embodiment, at least one optical surface of the fourth lens fourth may be an aspheric surface.

The condensing lens 410 of the projection optical system 400 is formed by a single lens, in which the condensing lens 410 has ninth and tenth optical surfaces S9 and S10, both of which are convex toward the screen side. Each of the ninth and tenth optical surfaces S9 and S10 is a spherical surface. Unlike the present embodiment, at least one optical surface of the condensing lens 410 may be an aspheric surface.

The central axis of the display device 300 may not coincide with the second optical axis 405 of the projection optical system 400 to provide a preset offset therebetween.

For example, the offset is expressed as a percentage with reference to a half of the length of the display panel 300. For example, when the central axis of the display device 300 and the second optical axis 405 of the projection optical system 400 coincide with each other, the offset will be 0%, and when the second optical axis 405 of the projection optical system 400 is positioned at an end of the display device 300, the offset will be 100%.

In order to reduce the volume of the projector 10, it is required to densely arrange all optical devices of the projector 10. In the present invention, by moving the illumination optical system 100 toward the projection lens 420 side (i.e., toward the screen side) along the x-axis (i.e., in the direction indicated by upward arrow 12), the thickness of projector 10 is reduced.

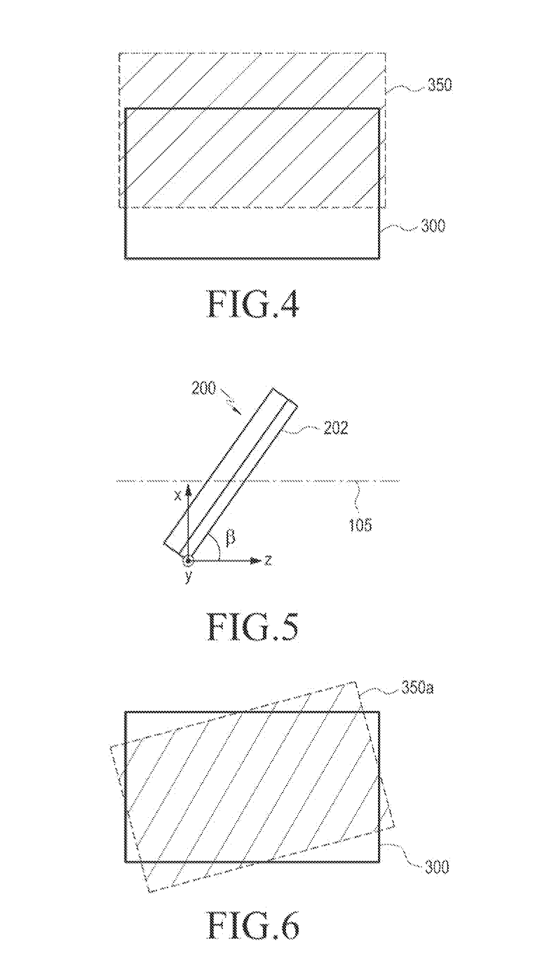

FIG. 4 illustrates a region of light illuminated to the display panel (i.e., an illumination region) when the illumination optical system is moved toward the projection lens side along the x-axis. As illustrated, it will be appreciated that as the illumination optical system 100 is moved toward the projection lens 420 side along the x-axis, the illumination region 350 is one-sided and dislocated without being coincident with the display panel 300.

FIG. 5 illustrates the rotation of a mirror. Prior to moving the illumination optical system 100, the mirror 200 forms a preset angle of inclination with the first optical axis 105. The reflection surface 202 of the mirror 200 is parallel to the y-axis. In order to correct the movement of the illumination region according to the movement of the illumination optical system 100 (i.e., in order to return the illumination region to the position before the movement), the mirror 200 is rotated clockwise with reference to the y-axis about the display panel 300 side end thereof to reduce the angle of inclination. The angle of inclination β of the mirror 200 in relation to the first optical axis 105 after being rotated is set in the range of 50 to 60 degrees.

FIG. 6 illustrates a region of light illuminated to the display panel when the mirror is rotated. It will be appreciated that as the mirror 200 is rotated in a direction to reduce the angle of inclination with the first optical axis 105, the illumination region 350a is returned to its original position in such a manner that the center of the illumination region 350a coincides with the center of the display panel 300 but the illumination region 350a does not coincide with the display panel 300 since the illumination region 350a has been rotated counterclockwise about the center thereof.

The present invention discloses a method of correcting the movement of the illumination region according to the movement of the illumination optical system 100 through the rotation of the mirror 200, and correcting the movement of the illumination region according to the rotation of the mirror 200 through the rotation of the equalization filter 180.

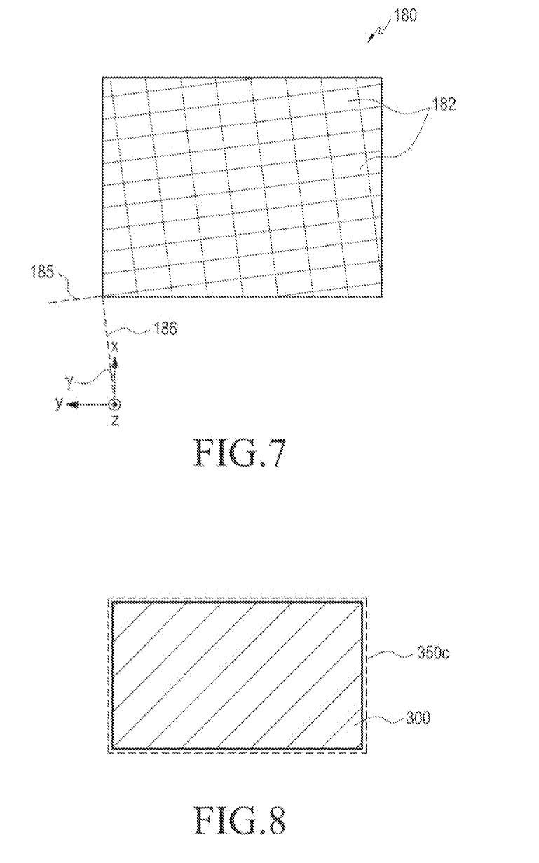

FIG. 7 illustrates the rotation of the equalization lens. Prior to moving the illumination optical system 100 and rotating the mirror 200, the alignment axes 185 and 186 of the micro lenses 182 of the equalization lens 200 (that is, the alignment axes in the row direction and column direction) are perpendicular or parallel to the second optical axis 405. Each of the alignment axes of the micro lenses 182 after being rotated is inclined in relation to second optical axis 405, and the angle of inclination y of the alignment axis 186 in the column direction of the micro lenses 182 in relation to the second optical axis 405 is set in the range of 5 to 15 degrees.

The alignment axis 186 in the column direction and the alignment axis 185 in the row direction are at right angles, the angle of inclination of the alignment axis 185 in the row direction in relation to the second optical axis 405 is set in the range of 75 to 85 degrees. When the illumination optical system 100 has been moved to the projection lens 420 side along the x-axis, and the mirror 200 has been rotated (or inclined) in a direction to reduce the angle of inclination in relation to the first optical axis 105, the equalization lens is rotated counterclockwise with reference to the z-axis. The present embodiment illustrates the manner in which a rectangular equalization lens is rotated, wherein the alignment axis of the equalization lens is initially parallel to the sides (two opposed sides among the four sides) of the equalization lens or perpendicular to the sides (the remaining two opposed sides among the four sides) of the equalization lens. Unlike the present embodiment, a rectangular equalization lens, of which the alignment axis is inclined in relation to the sides of the equalization lens, may be used, in which case the equalization lens may not be rotated.

FIG. 8 illustrates a region of light illuminated to the display panel when the equalization lens has been rotated. It will be appreciated that as the equalization lens is rotated counterclockwise about the z-axis, the illumination region of the light coincides with the display panel as illustrated.

In the present invention, the angle of inclination of the mirror 200 in relation to the first optical axis 105 is set in the range of 50 to 60 degrees, and the angle of inclination of the alignment angle of the equalization lens in relation to the second optical axis 405 is set in the range of 5 to 15 degrees.

The beam projector in accordance with the present invention has advantages in that the thickness thereof is reduced by moving an illumination optical system toward a screen side, and is reduced without deteriorating the illumination efficiency thereof by correcting the movement of an illumination region according to the movement of the illumination optical system through the rotation of a mirror, and correcting the movement of the illumination region according to the rotation of the mirror through the rotation of an equalization filter.

While embodiments of the present invention has been described, it will be obvious to those of ordinary skill in the art that various modifications can be made without departing from the scope of the present invention.

What is claimed is:

1. A projector for projecting light forming an image on an external screen to outside of the projector, comprising:
a display panel provided with a plurality of pixel elements, and configured to form an image by controlling the pixel elements according to a driving signal;
an illumination optical system provided with an equalization lens and a mirror arranged on a first optical axis, and configured to output light penetrating the equalization lens to the display panel through the mirror; and
a projection optical system provided with at least one lens arranged on a second optical axis, and configured to output light reflected from the display panel to the outside,
wherein an alignment axis of the equalization lens forms an angle of inclination with the second optical axis.

2. The projector of claim 1, wherein the equalization lens comprises a plurality of micro lenses arranged along the alignment axis.

3. The projector of claim 1, wherein the angle of inclination formed by the alignment axis of the equalization lens and the second optical axis is in the range of 5 to 15 degrees.

4. The projector of claim 1, wherein the angle of inclination formed by the mirror and the first optical axis is in the range of 50 to 60 degrees.

5. The projector of claim 1, wherein the projection optical system comprises:
a projection lens configured to adjust the focus of the light projected to the outside of the projector; and
a condensing lens arranged between the projection lens and the display panel, and configured to output the light reflected from the display panel to the projection lens after reducing a beam spot size of the reflected light.

6. The projector of claim 1, further comprising:
first and second light sources which output first and second primary color lights of different colors,
wherein the illumination optical system comprises a filter configured to transmit the first primary color light input from the first light source, and to reflect the second primary color light input from the second light source, thereby allowing the first and second primary color lights to progress along the first optical axis.

7. The projector of claim 6, wherein the illumination optical system further comprises a relay lens arranged between the filter and the mirror, and configured to focus light input from the filter.
